(19) United States
(12) Patent Application Publication
(10) Pub. No.: US 2012/0016752 A1
(43) Pub. Date: Jan. 19, 2012

(54) ONLINE ADVERTISING SYSTEM

(76) Inventor: Steve Crim, Fairhope, AL (US)

(21) Appl. No.: 13/115,959

(22) Filed: May 25, 2011

(51) Int. Cl. G06Q 30/00; G06F 17/00

(52) U.S. Cl. 705/14.73; 715/234

(57) ABSTRACT

A method, apparatus, and computer readable storage to display a new browser window behind a first displayed window without the user realizing the new browser window has been generated. A second window is generated in front of a first window, the first window is closed and regenerated, which results in the second window “behind” the first window.

### BACKGROUND OF THE INVENTION

1. Field of the Invention

The present general inventive concept is directed to a method, apparatus, and computer readable storage medium directed to a method, apparatus, and computer readable storage to display windows in a predetermined, arranged order.

2. Description of the Related Art

Hidden (or windows generated or deposited behind existing windows) are used by web sites to present a user with additional information that can help a web site market itself to consumers. Some browsers prohibit the immediate generation of new browser windows in front or back of an existing browser window.

What is needed is a method to generate a new browser window and the ability to arrange order to the original browser window.

### SUMMARY OF THE INVENTION

It is an aspect of the present invention to provide an improved way to present information on a web site.

The above aspects can be obtained by (a) requesting, receiving, and displaying a first web page from an electronic web server using a computer communications network; (b) displaying a second web page over the first web page; (c) removing the first web page; and (d) generating a new first web page over the second web page.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of displaying a new browser window with a prearranged display order, according to an embodiment;

FIG. 2 is a drawing of an output device showing a first window, according to an embodiment;

FIG. 3 is a drawing of an output device showing a second window opened over the first window, according to an embodiment;

FIG. 4 is a drawing of the output device showing the second window after the first window is closed, according to an embodiment;

FIG. 5 is a drawing of the output device showing the first window regenerated over the second window, according to an embodiment;

FIG. 6 is a block diagram of hardware that can be used to implement any of the digital computers/servers described herein, according to an embodiment;

FIG. 7 is a block diagram showing participants on a computer communications network, according to an embodiment;

FIG. 8 is a drawing of the output device showing the first window closed, according to an embodiment;

FIG. 9 is a drawing of the output device showing the second window opened after the first window was closed, according to an embodiment;

FIG. 10A is a drawing of an output device showing a first window and a hidden second window, according to an embodiment; and

FIG. 10B is a drawing of the output device showing the second window after the first window is closed, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a method for displaying a new browser window with the display order arranged, which is a window deposited behind a currently displayed window. A hidden window can be useful when a user is browsing a web site and the owner of the web site wishes that a second window is presented to the user when the user leaves the web site. The second window can be a window that helps close the sale to the user, for example it can be a contact window (where the user can enter his or her contact information), a special offer (e.g., the user can now receive a 10% discount on goods offered by the web site if the user orders immediately), etc. Some web designers may prefer that the second window is displayed as a hidden window while the user is browsing the web site so that the user is not distracted by the new browser window and closes it without reading the content. Once the user closes a first window on the web site, the new browser window (second window) will be displayed. The new browser (hidden) window is really a second window that is displayed “behind” the first window. In one embodiment, the new browser window is smaller in size than the first window so that the user does not see the second window until the user closes the first window (typically, web browsers do not display windows which are completely obstructed by another window), although in another embodiment the new browser window is larger in size to the first window so that it is visible behind the first window. Of course, the second window can also be equal in size to the first window.

The concepts describe herein use modern Internet and web browsing technology, which is described in U.S. Pat. No. 7,386,473, which is incorporated by reference in its entirety. Concepts can be used with web browsers such as INTERNET EXPLORER, CHROME, FIREFOX, etc.

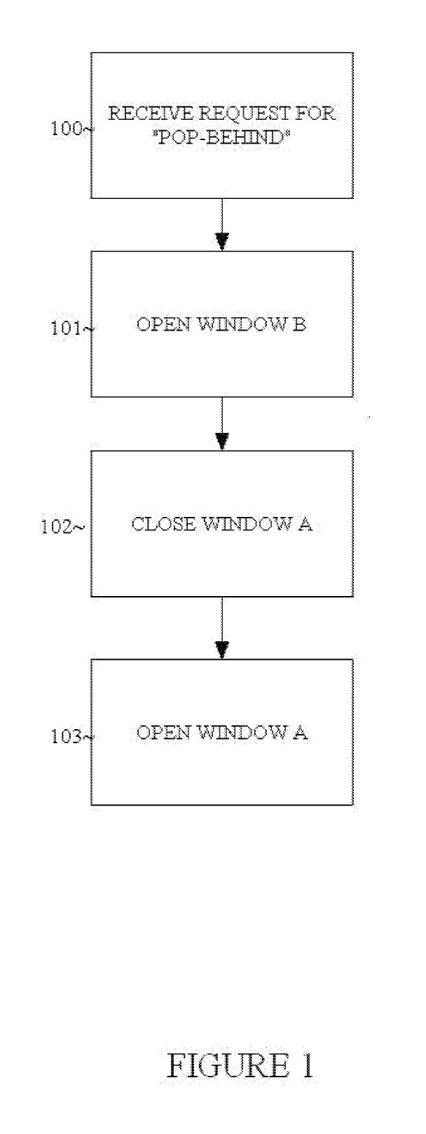

FIG. 1 is a flowchart illustrating an exemplary method of displaying a new browser window with a prearranged display order, according to an embodiment.

The method begins with operation 100 which receives a request to generate a new browser and arrange the order so that the new browser window appears behind the original browser window. A web page (displayed in “window A”) that is currently being displayed can contain a script (in for example, hmtl, javascript, etc.) which contains code to initiate the method illustrated in FIG. 100. When the code is run it is compiled in the user's browser and typically stays there until a cache is cleared. Once the code is being run, it does not depend on any given window and can still run even though the window it was originally associated with is closed.

From operation 100, the method proceeds to operation 101 which opens a new window B. New windows open “in front of” other windows, that is, new windows are typically shown in their entirety and block whatever windows are behind them. Thus, window B opens in front of window A. Because window B is typically smaller than window A, parts of window A will still be visible.

From operation 101, the method proceeds to operation 102, which closes window A. This is done using a command in the script.

From operation 102, the method proceeds to operation 103, which opens window A. Typically, the URL used in operation to open window A is the same URL that was used when window A was original opened. It is just ‘re-opened.” When window A is opened in operation 103, it is opened in front of window B and thus blocks window B from being visible (since typically window A is larger than window B).

A result of the method illustrated in FIG. 1 is that window B is now opened behind window A, yet the operations 101-103 happen so quickly that a user would typically not be able to discern that all of that has taken place. Thus, the user would not know there is a new window B behind window A, that is, until the user closes window A (or moves it).

Some modern browsers may prohibit “pop-behind” or hidden windows from being generated instantly. Nevertheless, the method illustrated in FIG. 1 is designed to defeat such prohibitions and still allow such a hidden window to be generated which can then be used for commercial purposes such as marketing.

The code listed in Appendix A is one example of javascript that can be used to implement the method illustrated in FIG. 1.

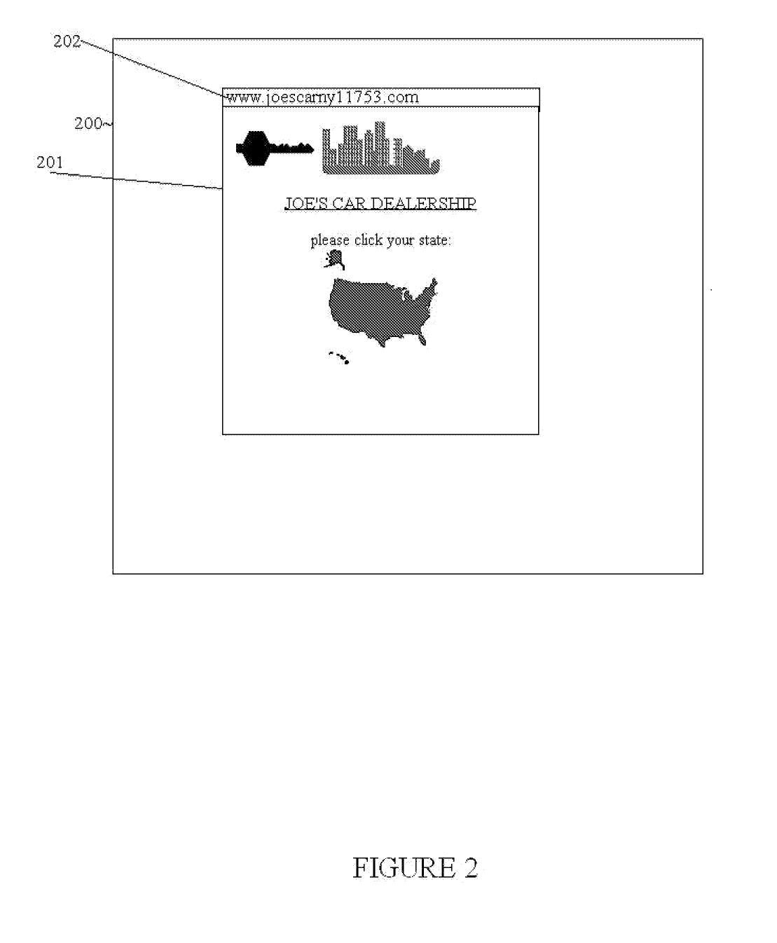

FIG. 2 is a drawing of an output device showing a first window, according to an embodiment.

An electronic video output device (LCD, CRT, etc.) 200 shows a first window 201 (or window A) which is a web browser window. The URL 202 for the first window is also displayed in the browser.

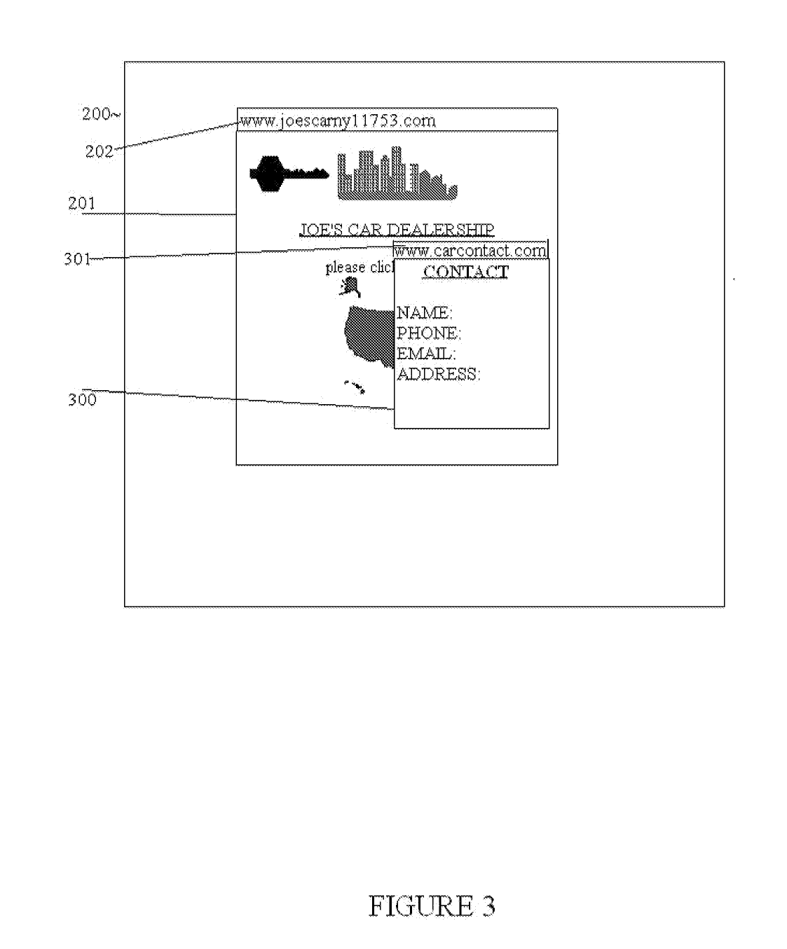

FIG. 3 is a drawing of an output device showing a second window opened over the first window, according to an embodiment.

A second window 300 (or window B) is opened by a script (or program) running (in operation 101 from FIG. 1). Browsers typically open new windows over prior windows. The second window 300 is another web page with its own URL 301 (which is different than the URL 202 for the first window). It is noted that in this embodiment, the second window is smaller than the first window and is positioned so that the there is no part of the second window which extends beyond the first window. In another embodiment, the second window can be the same size, or larger, than the first window.

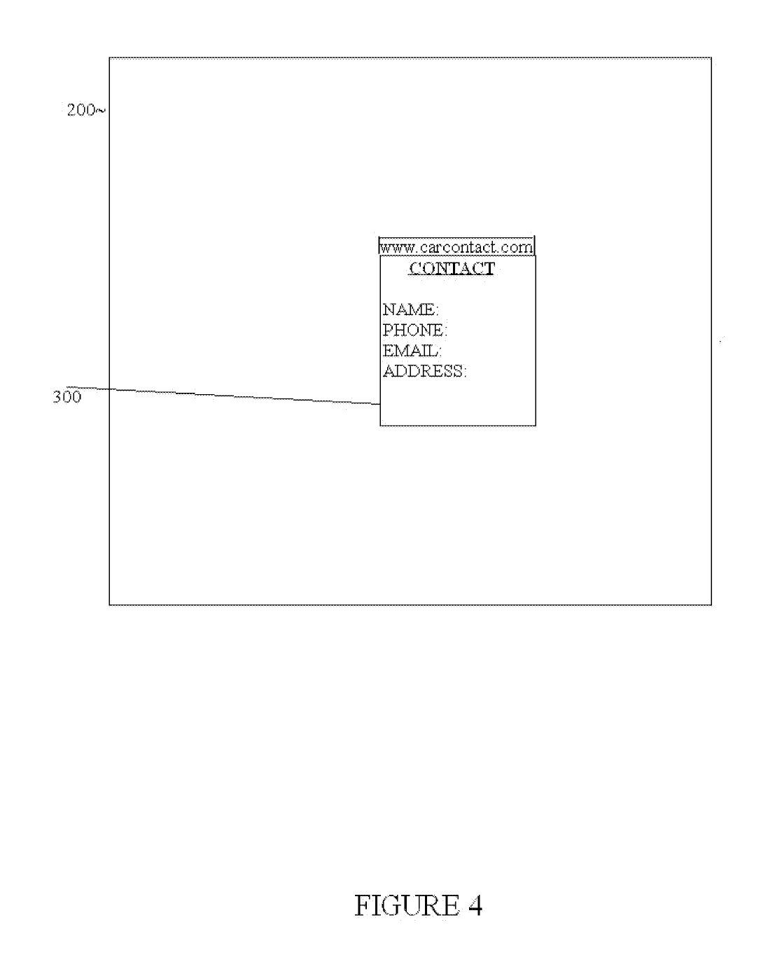

FIG. 4 is a drawing of the output device showing the second window after the first window is closed, according to an embodiment.

The script running then closes the first window 201, leaving the second window 300 (in operation 102 from FIG. 1).

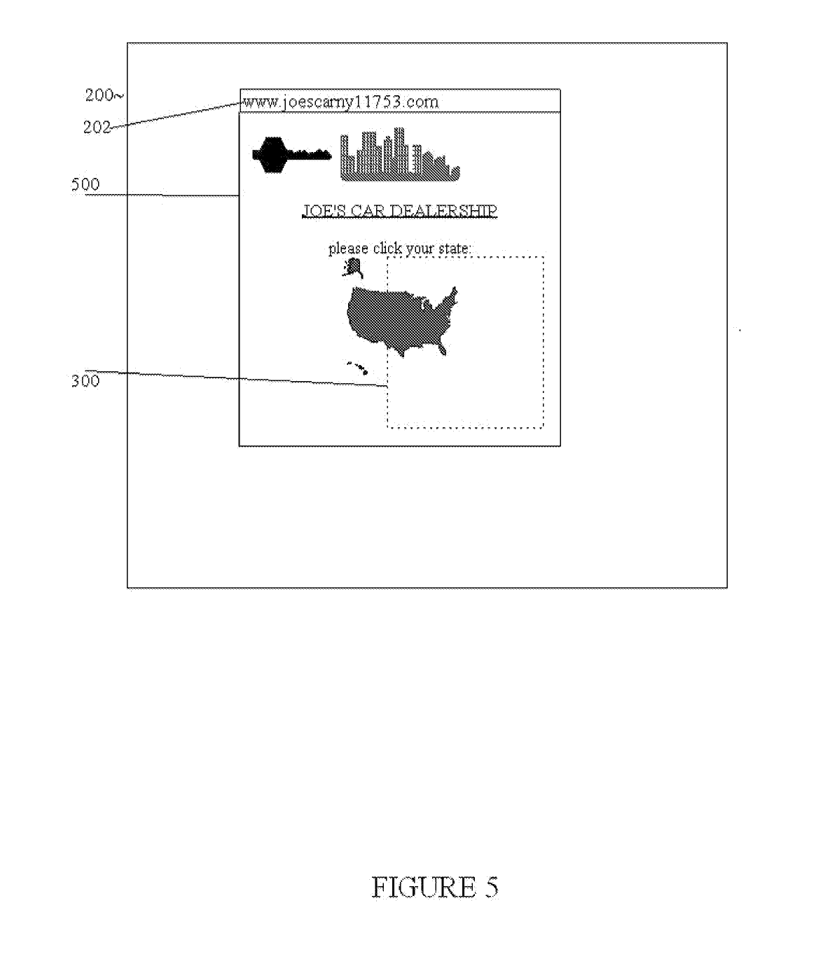

FIG. 5 is a drawing of the output device showing the first window regenerated over the second window, according to an embodiment.

In operation 105 (from FIG. 1), a new first window 500 is opened which uses the URL 202 from the first window. The new first window 500 opens over the second window 300 which is now arranged behind the original window (and thus hidden from view). Note that the second window 300 is smaller than the new first window 500 and also does not extend beyond the new first window 500, thus making it invisible to the user because it is completely covered by the new first window 500. Thus, there is now a hidden window (second window 300) on the user's output device 200 which the user typically will not know about until the user manually closes (or manually moves) the new first window 500. The user won't typically know that the hidden window exists because operations 101-103 (and FIGS. 3-5) occur so quickly the human eye will typically not be able to notice these operations happening. Note that the new first window 500 is typically identical in size and location (and content) to the original first window 201 so that the user will not notice there is any difference. In fact, typically, the only difference between the first window 201 and the new first window 500 is the time they were generated.

The second window 300 can be a contact information window (which prompts the user to enter his or her contact information which is then stored so that the user can be contacted at a later point in time) or some other window which continues the goal of marketing to the user. Thus, the web site (serving the first window 201) now has a “second chance” to try to capture the user's attention and sell him or her something or at least get their contact information. Without this second chance, the user will be gone from the web site and may never return.

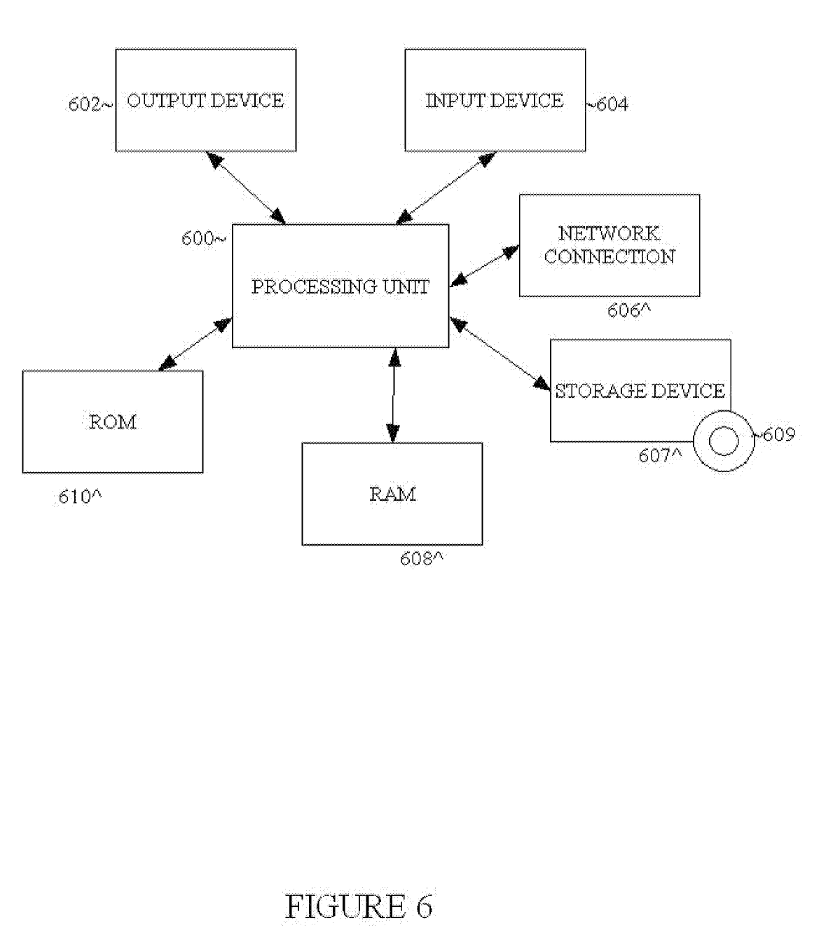

FIG. 6 is a block diagram of hardware that can be used to implement any of the digital computers/servers described herein, according to an embodiment.

A processing unit 600 (such as a microprocessor and associated apparatus such as bus, cache, etc.) can be connected to an output device 602 (such as an LCD screen, touch-screen, speaker, etc.) and an input device 604 (such as a touch-screen, keyboard, mouse, buttons, etc.) The processing unit 600 can also be connected to a network connection 606 (such as an LAN, WAN, wifi, Internet, etc.) The processing unit 600 can also be connected to a RAM 608 and a ROM 610. The processing unit 600 can also be connected to a storage device 607 (e.g., hard disk, CD-ROM, DVD-drive, BLU-RAY, EPROM, etc.) which can read an appropriate computer readable storage medium 609 (such as a CD-ROM, etc.) that stores a program that controls the processing unit 600 to implement any of the methods described herein.

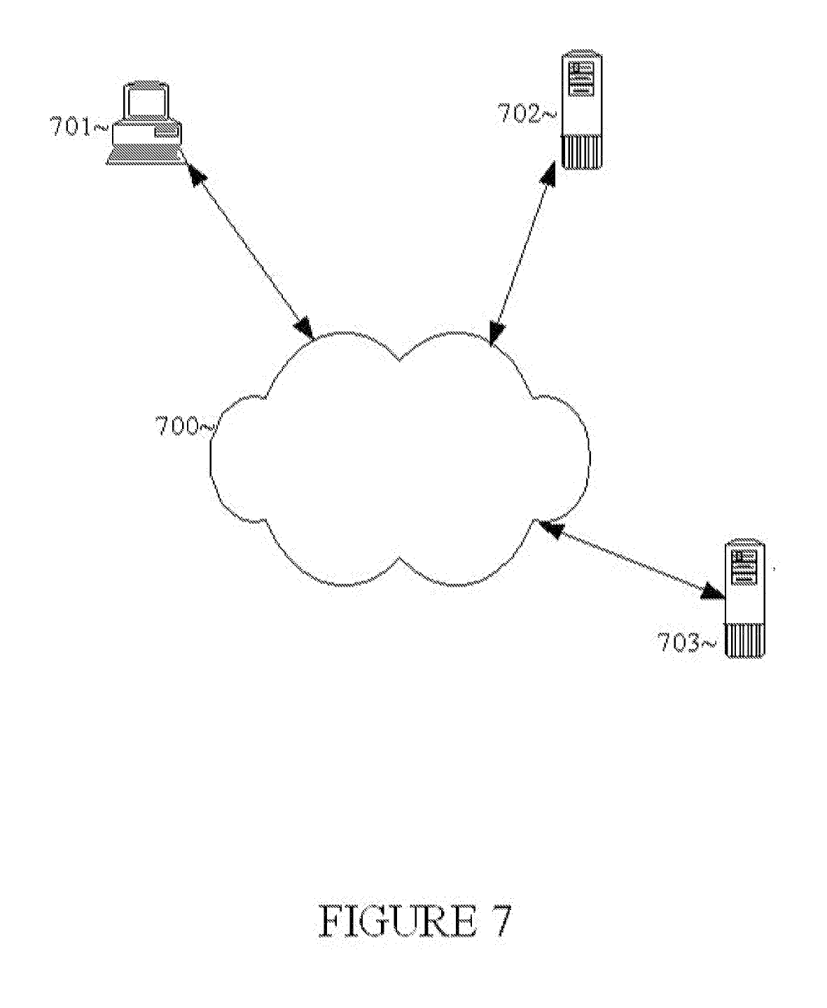

FIG. 7 is a block diagram showing participants on a computer communications network, according to an embodiment.

A computer communications network 700 (such as the Internet) can be used to connect numerous parties. For example, user 701 is a client using a remote personal computer that is running a web browser. The user 701 visits a web site which is hosted by server 702. The first server 702 can serve the first web window 201 (from FIG. 2) to the user. A second server 703 can serve the second web window (400 from FIG. 4) to the user. It is noted that the second web window (400 from FIG. 4) can also be served from the first server 702.

The embodiment described in FIGS. 1-5 operate by generating the second window over the first window, then deleting the first window, then regenerating a new first window. In another embodiment, the hidden window can be generated (after FIG. 2) by deleting the first window, generating the second window, and then generating a new first window over the second window. This is similar to the method illustrated in FIG. 1 but using a different order of operations (operations 101 and 102 are switched).

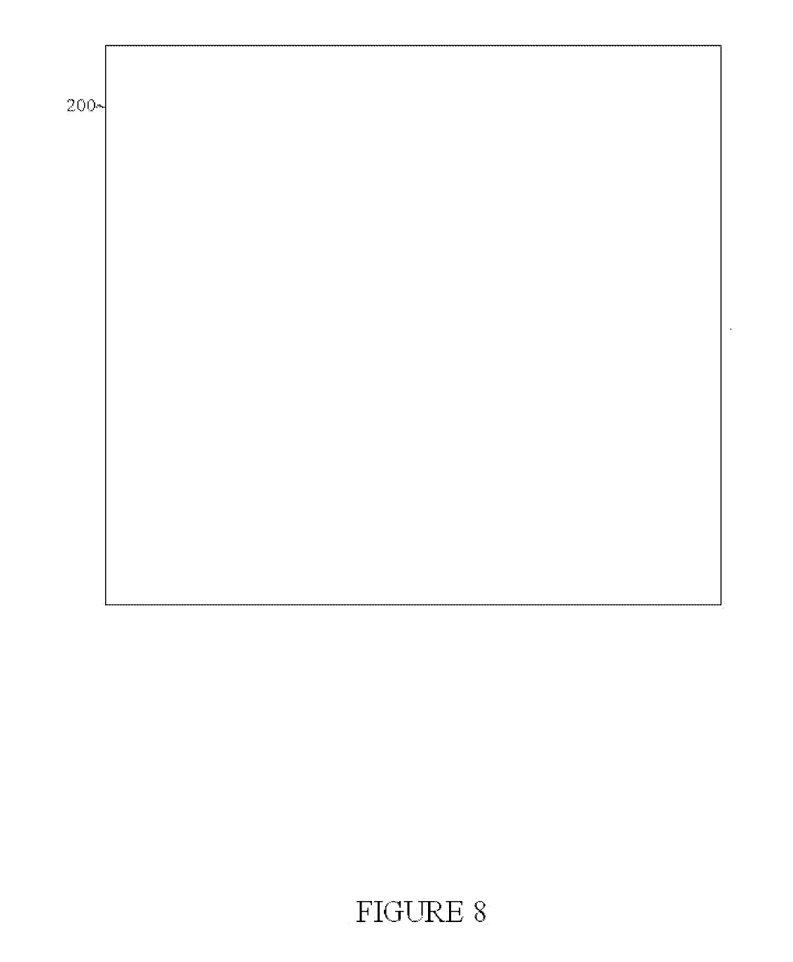

FIG. 8 is a drawing of the output device showing the first window closed, according to an embodiment.

After FIG. 2, the first window (or window A) 201 is closed.

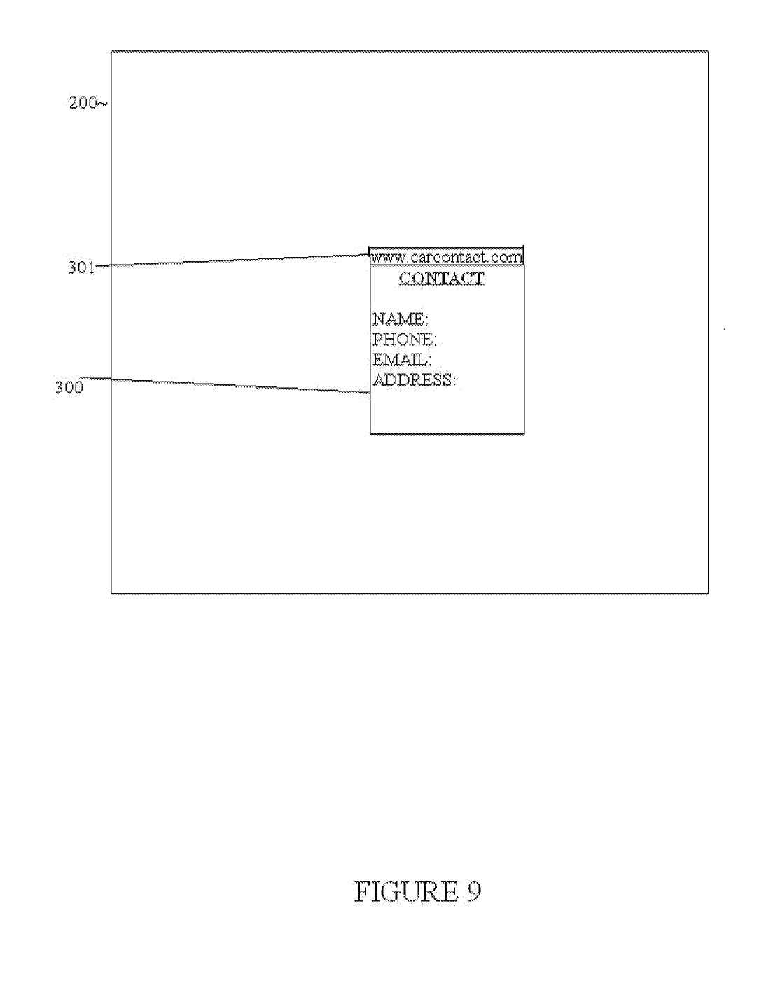

FIG. 9 is a drawing of the output device showing the second window opened after the first window was closed, according to an embodiment.

After FIG. 3, the second window (or window B) 300 is generated using a second window URL 301.

From FIG. 9, then operation 103 is performed which results in FIG. 5.

Thus, FIGS. 8-9 are perform the same operations shown in FIGS. 3-4 but in reverse order. Either method should typically work to achieve the goals of the methods described herein.

The second web page 300 (see FIG. 5), which is the web page that can be considered the hidden web page, can be set to be any web page found on the Internet. For example, it can contain geographically targeted advertisements or offers; or it can contain behaviorally-targeted advertisements or offers.

The second web page can also be rotated among several different web pages so that the effectiveness of each particular page can be measured and tracked. The several different web pages may (or may not) be weighted so certain pages appear more often.

The second web page can be paid for by a subscribing advertiser (which may or may not be affiliated with the host web site that served the first page/window). Thus, this subscribing advertiser may pay a fee (e.g., $0.10 per second page served) so that they may collect contact information (if the second page can receive contact information) from the visitor.

The host web site (served by first server 702) which includes the first web window can also sell visitors goods using the shopping cart approach (which is well known in the art, wherein visitors select items to put in their shopping cart, and when they click a button to check out, they can pay for the contents in their shopping cart). It is common for visitors of a web site to abandon their shopping cart (after they have added items into it) without paying for it. The second window/page can include the abandoned (or updated) shopping cart from the host web site. Thus, for example, a user can visit a web site hosted by first server 702 and is presented with the first window (web page) and can browse the site to view many other pages. On these pages the user is allowed to add items to a shopping cart and check out (purchase) the items in the shopping cart (using a credit card, etc.) The second (hidden) window can contain the user's shopping cart, so if the user closes the first window (with the intent to leave the web site without making a purchase) the user is presented with his/her shopping cart in the second window, giving the user yet another chance to complete the purchase.

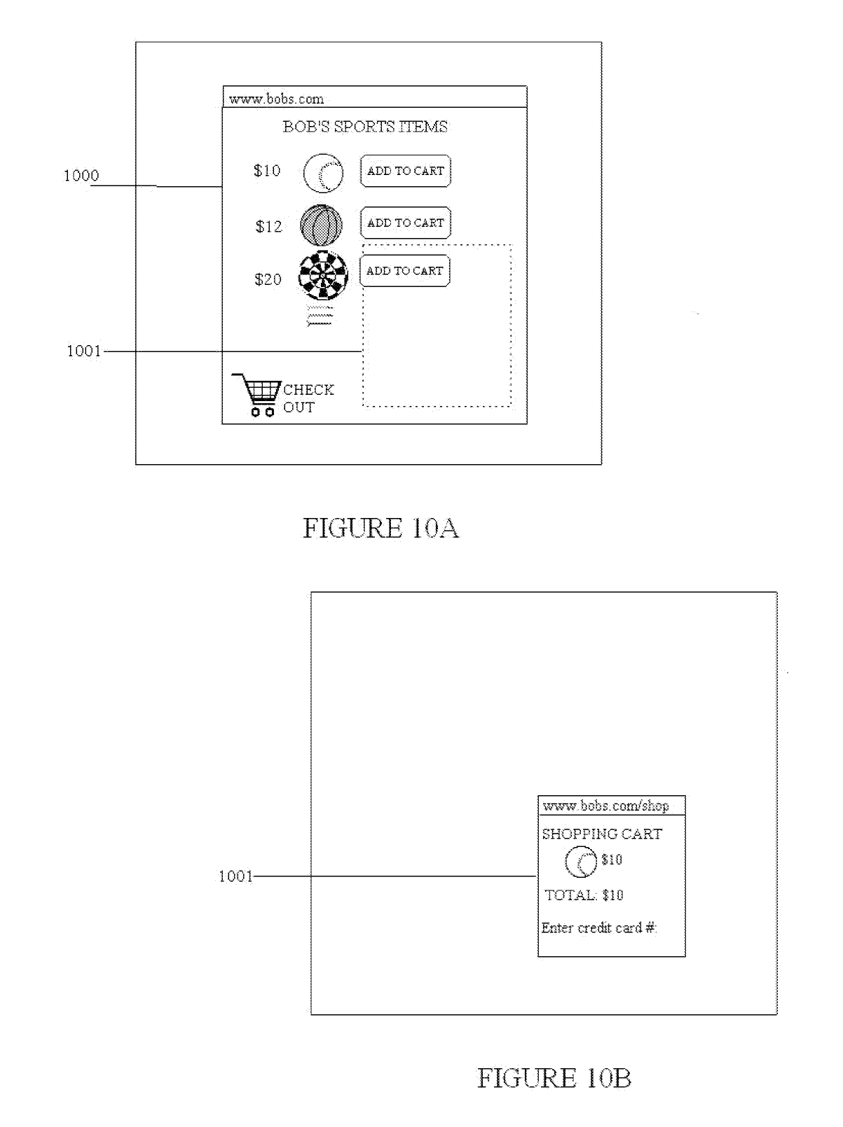

FIG. 10A is a drawing of an output device showing a first window and a hidden second window, according to an embodiment.

A first window/page 1000 shows a web page with a sales system that allows users (visitors) to select items to add to their shopping cart. A check out icon is displayed that when clicked, displays the contents of the user's shopping cart (the items the user has clicked to add) and the user can then enter his/her payment and shipping information to complete the purchase.

Second (hidden) window/page 1001 is not visible to the user but was generated using the methods described herein (it can be generated periodically or when the first page is generated). The second window 1001 can also be generated when any other page (or select pages) of the host web site (which serves the first page 1001 and other pages) is generated using the methods described herein (to arrange the second window 1001 so it is behind the first window 1000). As such, the web site can be a sales site (as known in the art) which has various pages with information about items and also allows users to purchase items by adding items to their shopping cart and then checking out. When the user visits some (or all) pages on this web site, when the new page is displayed the second window 1001 is also generated and can be arranged behind the first window (using all the methods described herein) with the current contents of the user's shopping cart. In FIG. 10A, the second window 1001 is hidden behind the first window 1000 (while the user is still shopping and browsing different web pages on the web site served by the server (which can be, for example, server 702). In this example, the user has added the baseball to his/her shopping cart, but instead of clicking the icon to check out, the user then closes the first window 1000.

FIG. 10B is a drawing of the output device showing the second window after the first window is closed, according to an embodiment.

When the user closes the first window 1000 in FIG. 10A, the second window 1001 now becomes visible which displays the user's current contents of his/her shopping cart (which contains the baseball that the user had previously added). The user can now enter his/her credit card information (and other purchase information such as shipping address etc.) and complete the purchase directly in the second window 1001 so the user can complete the purchase and receive his/her items.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

APPENDIX A
<!--
var cookie_persistence_days = 1;
popNotOpenedYet = true;
if (!mobiledetection(navigator.userAgent∥navigator.vendor∥window.opera)) {

document.onclick = function( ) {

if (document.cookie.indexOf(“popopened3=”) != −1) { popNotOpenedYet

= false; }

if(popNotOpenedYet) {

if (/Chrome[\/\s](\d+\.\d+)/.test(navigator.userAgent) ∥

/Firefox\/4/.test(navigator.userAgent)) {

popwinOBJz =

window.open(‘http://www.candsleads.com/1stc/[T2]/2ndchance/index.html’, ‘nameMe11’,
‘toolbar=1,menubar=1,scrollbars=1,status=0,location=1,resizable=1,top=0,left=0’);

var URL = window.location;
if (window.detwin) {

window.detwin.close( );
window.detwin = null;

}
window.detwin = window.open(URL, ‘mainwindow’);
window.detwin.focus( );
window.detwin.close( );

}
else if (/iPad/.test(navigator.userAgent)) {

popwinOBJz =

window.open(‘http://www.candsleads.com/1stc/[T2]/2ndchance/index.html’, ‘nameMe11’,
‘toolbar=1,menubar=1,scrollbars=1,status=0,location=1,resizable=1,top=0,left=0’);

window.focus( );

}
else {

popwinOBJz =

window.open(‘http://www.candsleads.com/1stc/[T2]/2ndchance/index.html’, ‘nameMe11’,
‘toolbar=1,menubar=1,scrollbars=1,status=0,location=1,resizable=1,top=0,left=0’);

popwinOBJz.blur( );

}
popNotOpenedYet = false;
var expiry_date = new Date( );
expiry_date.setDate(expiry_date.getDate( ) +

cookie_persistence_days);

document.cookie = “popopened3=1;expires=” +

expiry_date.toGMTString( );

}

}

}
else {

//alert(“do nothing for mobile”);

}
function mobiledetection(a) {

if

(/android|avantgo|blackberry|blazer|compal|elaine|fennec|hiptop|iemobile|ip(hone|od)|iris|
kindle|lge |maemo|midp|mmp|opera m(ob|in)i|palm(
os)?|phone|p(ixi|re)\/|plucker|pocket|psp|symbian|treo|up\.(browser|link)|vodafone|wap|wi
ndows (ce|phone)|xda|xiino/i.test(a)∥/1207|6310|6590|3gso|4thp|50[1-6]i|770s|802s|a
wa|abac|ac(er|oo|s\-
)|ai(ko|rn)|al(av|ca|co)|amoi|an(ex|ny|yw)|aptu|ar(ch|go)|as(te|us)|attw|au(di|\-m|r |s
)|avan|be(ck|ll|nq)|bi(lb|rd)|bl(ac|az)|br(e|v)w|bumb|bw\-(n|u)|c55\/|capi|ccwa|cdm\-
|cell|chtm|cldc|cmd\-|co(mp|nd)|craw|da(it|ll|ng)|dbte|dc\-
s|devi|dica|dmob|do(c|p)o|ds(12|\-d)|el(49|ai)|em(12|ul)|er(ic|k0)|esl8|ez([4-
7]0|os|wa|ze)|fetc|fly(\-|_)|g1 u|g560|gene|gf\-5|g\-mo|go(\.w|od)|gr(ad|un)|haie|hcit|hd\-
(m|p|t)|hei\-|hi(pt|ta)|hp( i|ip)|hs\-c|ht(c(\-| |_|a|g|p|s|t)|tp)|hu(aw|tc)|i\-(20|go|ma)|i230|iac(
|\-|\/)|ibro|idea|ig01|ikom|im1k|inno|ipaq|iris|ja(t|v)a|jbro|jemu|jigs|kddi|keji|kgt(
|\/)|klon|kpt |kwc\-|kyo(c|k)|le(no|xi)|lg( g|\/(k|l|u)|50|54|e\-|e\/|\-[a-w])|libw|lynx|m1\-
w|m3ga|m50\/|ma(te|ui|xo)|mc(01|21|ca)|m\-
cr|me(di|rc|ri)|mi(o8|oa|ts)|mmef|mo(01|02|bi|de|do|t(\-| |o|v)|zz)|mt(50|p1|v
)|mwbp|mywa|n10[0-2]|n20[2-3]|n30(0|2)|n50(0|2|5)|n7(0(0|1)|10)|ne((c|m)\-
|on|tf|wf|wg|wt)|nok(6|i)|nzph|o2im|op(ti|wv)|oran|owg1|p800|pan(a|d|t)|pdxg|pg(13|\-([1-
8]|c))|phil|pire|pl(ay|uc)|pn\-2|po(ck|rt|se)|prox|psio|pt\-g|qa\-a|qc(07|12|21|32|60|\-[2-7]|i\-
)|qtek|r380|r600|raks|rim9|ro(ve|zo)|s55\/|sa(ge|ma|mm|ms|ny|va)|sc(01|h\-|oo|p\-
)|sdk\/|se(c(\-|0|1)|47|mc|nd|ri)|sgh\-|shar|sie(\-|m)|sk\-
0|sl(45|id)|sm(al|ar|b3|it|t5)|so(ft|ny)|sp(01|h\-|v\-|v
)|sy(01|mb)|t2(18|50)|t6(00|10|18)|ta(gt|lk)|tcl\-|tdg\-|tel(i|m)|tim\-|t\-mo|to(pl|sh)|ts(70|m\-
|m3|m5)|tx\-9|up(\.b|g1|si)|utst|v400|v750|veri|vi(rg|te)|vk(40|5[0-3]|\-
v)|vm40|voda|vulc|vx(52|53|60|61|70|80|81|83|85|98)|w3c(\-|)|webc|whit|wi(g
|nc|nw)|wmlb|wonu|x700|xda(\-|2|g)|yas\-|your|zeto|zte\-/i.test(a.substr(0,4)))

{

return true;

}
else {

return false;

}

}
//-->

What is claimed is:

1. A computer implemented method to display a new browser window, the method comprising:
requesting, receiving, and displaying a first web page from an electronic web server using a computer communications network;
displaying a second web page over the first web page;
closing the first web page; and
generating a new first web page over the second web page causing the second page to appear behind the first page.

2. The method as recited in claim 1, wherein a URL for first web page is the same as the URL for the new first web page.

3. The method as recited in claim 1, wherein the second web page is smaller than the first web page.

4. The method as recited in claim 3, wherein after the generating, the second web page is completely covered by the first web page.

5. The method as recited in claim 1, wherein the second web page is a contact information page which receives contact information and stores it in a database.

6. The method as recited in claim 1, wherein the second web page contains advertising.

7. The method as recited in claim 1, wherein the second web page is rotated among various web pages.

8. The method as recited in claim 1, wherein the second web page contains advertising for a subscribing advertiser.

9. The method as recited in claim 1, wherein the second web page contains an abandoned or updated shopping cart from a host web site that served the first page.

10. The method as recited in claim 1, wherein the second web page contains a geographically targeted advertisement.

11. The method as recited in claim 1, wherein the second web page contains a behaviorally targeted advertisement.

12. A computer implemented method to display a hidden window, the method comprising:
requesting, receiving, and displaying a first web page from an electronic web server using a computer communications network;
closing the first web page;
displaying a second web page; and
generating a new first web page over the second web page.

13. The method as recited in claim 12, wherein a URL for first web page is the same as the URL for the new first web page.

14. The method as recited in claim 12, wherein the second web page is smaller than the first web page.

15. The method as recited in claim 12, wherein after the generating, the second web page is completely covered by the first web page.

16. The method as recited in claim 12, wherein the second web page is a contact information page which receives contact information and stores it in a database.

17. The method as recited in claim 12, wherein the second web page is rotated among various web pages.

18. The method as recited in claim 12, wherein the second web page contains an abandoned or updated shopping cart from a host web site that served the first page.

19. An apparatus, comprising:
an electronic input device;
an electronic output device;
a processor operationally connected to the input device and the output device, the processor programmed to perform:
requesting, receiving, and displaying a first web page from an electronic web server using a computer communications network;
displaying a second web page over the first web page;
closing the first web page; and
generating a new first web page over the second web page causing the second page to appear behind the first page.

20. The apparatus as recited in claim 19, wherein a URL for first web page is the same as the URL for the new first web page.
